(19) United States
(12) Patent Application Publication
(10) Pub. No.: US 2005/0060282 A1
(43) Pub. Date: Mar. 17, 2005

(54) Patent family downloading system and method using selected downloading object

(76) Inventors: Qing-Ming Wu, Shenzhen (CN); Chien-Fa Yeh, Tu-Chen (TW); Chung-I Lee, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/940,285

(22) Filed: Sep. 13, 2004

(30) Foreign Application Priority Data
Sep. 12, 2003 (TW) 92125271

(51) Int. Cl. G06F 7/00

(52) U.S. Cl. 707/1

(57) ABSTRACT

A patent family downloading system includes a plurality of client computes (10) for providing interactive user interfaces for setting patent downloading conditions and displaying patent family downloading statues; an application server (12) comprising a patent downloading module (120) for downloading patent information from at least one remote database server according to patent downloading conditions set by users, a downloading condition generating module (121) for generating one or more patent family downloading conditions according to a patent selected as a patent family downloading object that needs to be downloaded, a patent family downloading module (122) for downloading patent information on a patent family from a patent family database server according to the patent family downloading conditions, and a monitoring module (123) for automatically monitoring patent family downloading statues; and a local database server (15) for storing the patent information. A related patent family downloading method is also provided.

### BACKGROUND OF THE INVENTION

1. Field of the Invention

The present invention relates to information downloading systems and methods, and particularly to patent family downloading systems and methods using selected downloading object.

2. Background of the invention

A “patent family” conventionally refers to a group of patents which have a same legal priority. These patents are filed in different national patent offices and/or in international patent organizations. The patent that is filed first in time is regarded as a basic patent for other patents in the patent family.

Patent information includes vast amounts of technological information, legal information, economic information and commercially strategic information. Analysis of patent family information can help companies comprehend their competitor's product strategies and development in a particular technological field. For instance, patent family analysis of a particular company can help to gauge strategies of patent distribution and product development of that company. In addition, patent family analysis of a particular technological field can help to understand a state of development of the technology in various countries and regions.

Some private sources, such as the LexisNexis Corporation's patent family database, provide patent family information that is accessible through the source's own website. Another example is the HKPC (Hong Kong Productivity Center), which provides an Intellectual Property Service Center (IPSC) enabling users to search patent family information according to manually input patent registered numbers or company names. However, when users download patents according to a group of patent numbers, they usually need to input the patent numbers one by one. Furthermore, when the scope of patents to be analyzed is very wide, the users may need to repeat the procedure of inputting patent numbers and analysis conditions several times. These difficulties make patent family searching unduly laborious and time-consuming. A patent family downloading system and method which can overcome the above-mentioned problems is desired.

### SUMMARY OF THE INVENTION

Accordingly, a main objective of the present invention is to provide a system and method for conveniently downloading patent family information.

To accomplish the above objective, a patent family downloading system in accordance with a preferred embodiment of the present invention comprises a plurality of client computers for providing interactive user interfaces for setting patent downloading conditions and displaying patent family downloading statues; an application server comprising a patent downloading module for downloading patent information from at least one remote database server according to patent downloading conditions set by users, a downloading condition generating module for generating one or more patent family downloading conditions according to a patent selected as a patent family downloading object that needs to be downloaded, a patent family downloading module for downloading patent information on a patent family from a patent family database server according to the patent family downloading conditions, and a monitoring module for automatically monitoring patent family downloading statues; and a local database server for storing the patent information.

Further, the present invention provides a method for downloading patent families, the method comprising the steps of: (a) setting one or more patent downloading conditions; (b) downloading patents according to the patent downloading conditions; (c) selecting a patent as a patent family downloading object; (d) generating patent family downloading conditions; (e) searching for patents belonging to the selected patent family; and (f) monitoring a downloading status.

In summary, the patent family downloading system and method are fast and convenient, because they provide downloading of patent families without inputting of patent numbers one by one.

Other objects, advantages and novel features of the present invention will be drawn from the following detailed description with reference to the attached drawings, in which:

### BRIEF DESCRIPRTION OF THE DRAWINGS

FIG. 1 is a schematic diagram of hardware infrastructure of a patent family downloading system in accordance with a preferred embodiment of the present invention;

FIG. 2 is a schematic diagram of main function units of an application server of the patent family downloading system of FIG. 1;

FIG. 3 is a diagram showing data flow of the patent family downloading system; and

FIG. 4 is a flowchart of a preferred method for downloading patent families according to the present invention.

### DETAILED DESCRIPTION OF THE INVENTION

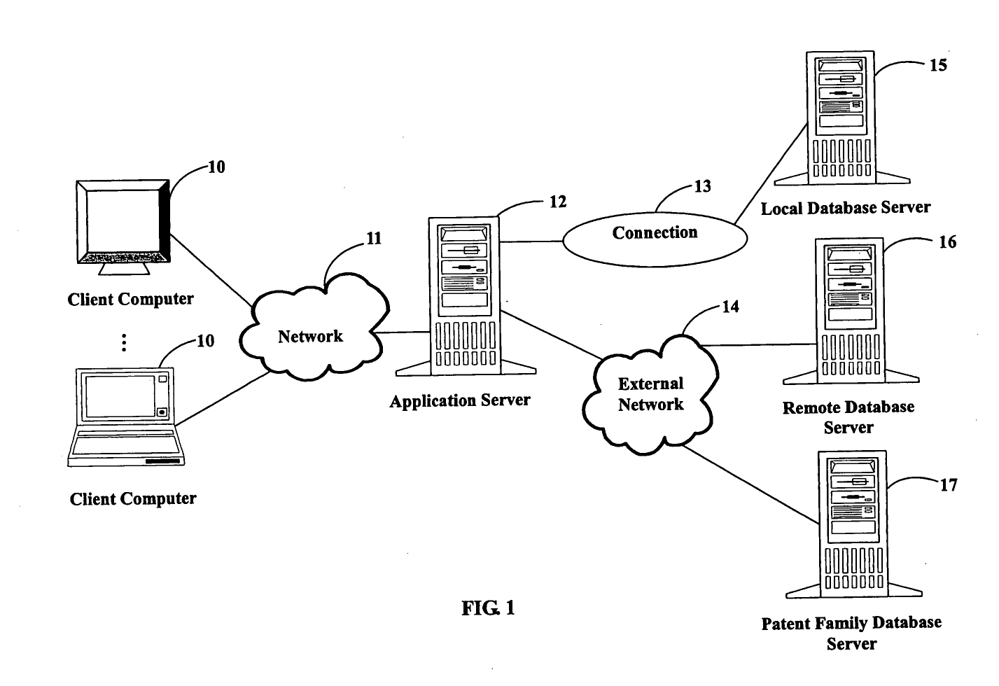

FIG. 1 is a schematic diagram of hardware infrastructure of a patent family downloading system in accordance with the preferred embodiment of the present invention. The patent family downloading system comprises a plurality of client computers 10, an application server 12, a local database server 15, at least one remote database server 16 (only one shown), and a patent family database server 17. The client computers 10 are connected to the application server 12 through a network 11. The application server 12 is connected to the local database server 15 through a connection 13. The connection 13 is database connectivity such as an ODBC (Open Database Connectivity) or a JDBC (Java Database Connectivity). The application server 12 is connected to the remote database server 16 and the patent family database server 17 through an external network 14. The external network 14 may for example be the Internet. The local database server 15 stores information downloaded from the remote database server 16 and the patent family database server 17. The remote database server 16 and the patent family database server 17 provide patent searching tools for users.

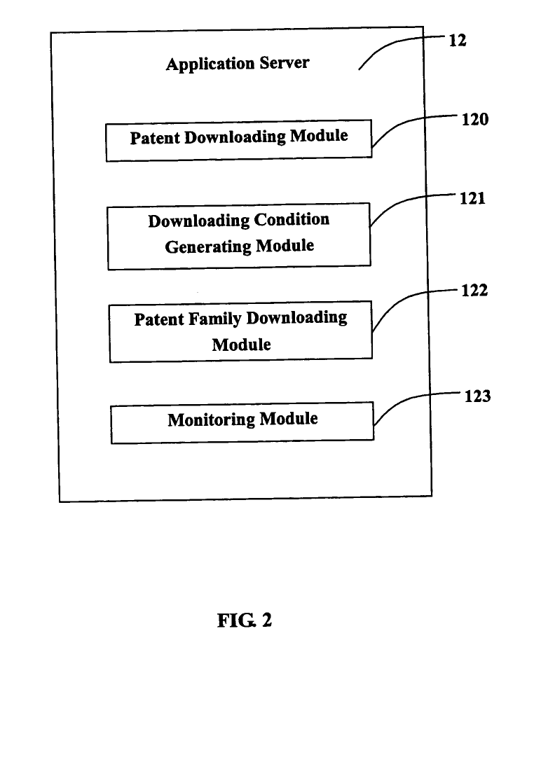

FIG. 2 is a schematic diagram of main function modules of the application server 12. The application server 12 comprises a patent downloading module 120, a downloading conditions generating module 121, a patent family downloading module 122, and a monitoring module 123. The patent downloading module 120 downloads patent lists and detailed patent information from the remote database server 16 according to downloading conditions input by users. The detailed patent information includes patent numbers, patent names, patent abstracts, patent priorities, patent assignees, patent specifications and patent figures. Each client computer 10 includes an interactive user interface for users to set patent downloading conditions. The patent downloading conditions can be patent numbers, patent names, patent assignees, patent inventors, key words included in patent abstracts, and key words included in patent specifications. The downloading conditions generating module 121 generates patent family downloading conditions according to patent family downloading objects that need to be downloaded. In the preferred embodiment, patent numbers are set as default downloading conditions. The patent family downloading module 122 downloads patent information on a patent family from the patent family database server 17 through the external network 14, according to the above generated downloading conditions. The monitoring module 123 automatically monitors patent family downloading statuses, and displays the downloading statuses through the client computers 10. Various downloading statuses include patents that have been downloaded, patents that have failed to be downloaded, and a status of any patent that is currently being downloaded. The downloading statuses can be automatically updated, and displayed on any of the client computers 10. This gives users real-time downloading status information, and helps users handle any abnormalities occurring in a downloading process.

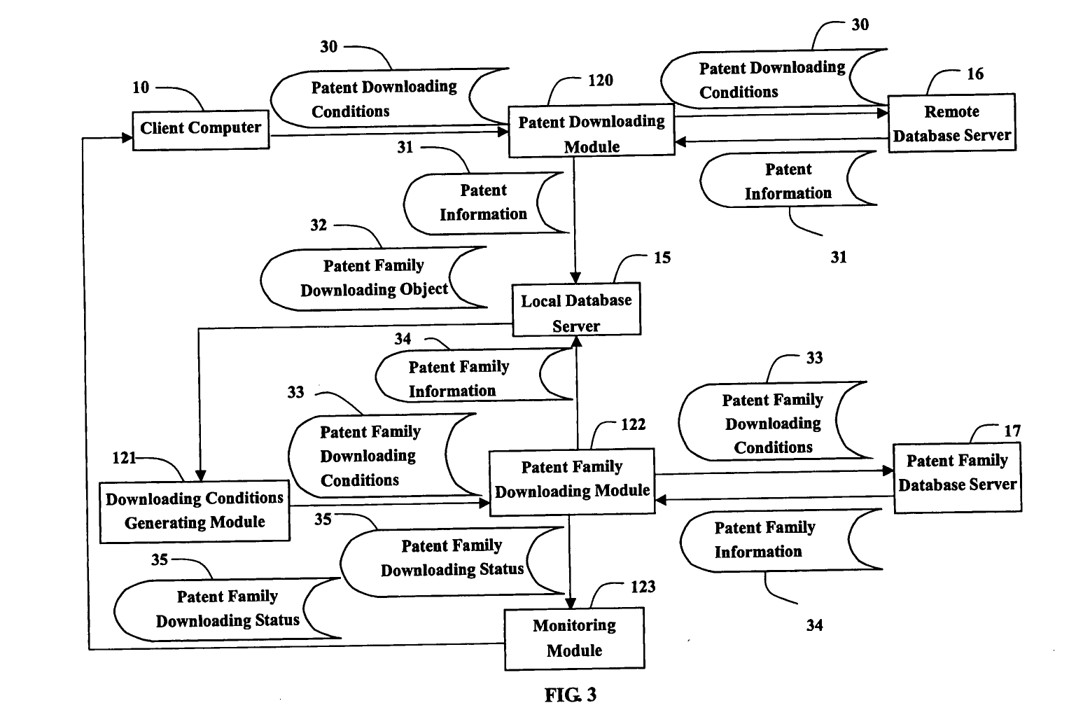

FIG. 3 is a diagram showing data flow of the patent family downloading system. Users set patent downloading conditions 30 through any one of the client computers 10. The patent downloading module 120 transmits the patent downloading conditions 30 to the remote database server 16 to obtain patent information 31, and stores the patent information 31 in the local database server 15. Patents included in the patent information 30 are regarded as patent family downloading objects 32. The downloading conditions generating module 121 generates patent family downloading conditions 33 according to a selected patent family downloading object 32, and transmits the patent family downloading conditions 33 to the patent family downloading module 122. The patent family downloading module 122 transmits the patent family downloading conditions 33 to the patent family database server 17, in order to search for patent family information 34. The patent family information 34 is received by the patent family downloading module 122, and stored in the local database server 15. The monitoring module 123 automatically monitors a patent family downloading status 35, and transmits the patent family downloading status 35 to the client computer 10.

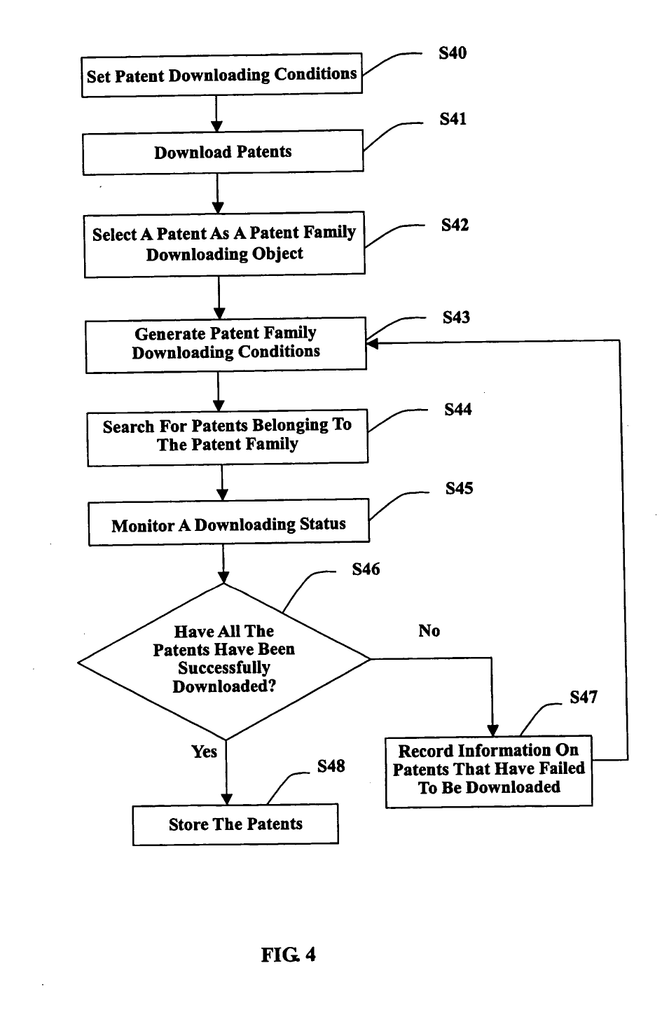

FIG. 4 is a flowchart of a preferred method for downloading patents of a patent family according to the present invention. In step S40, a user sets patent downloading conditions through a client computer 10. In step S41, the patent downloading module 120 transmits the set patent downloading conditions to the remote database server 16 through the external network 14. The remote database server 16 searches for detailed patent information according to the patent downloading conditions, and transmits the detailed patent information to the patent downloading module 120. The detailed patent information is then stored in the local database server 15. In step S42, the user selects a patent from the patents included in the detailed patent information as a patent family downloading object. In step S43, the downloading conditions generating module 121 generates patent family downloading conditions according to the patent family downloading object. In step S44, the patent family downloading module 122 transmits the generated patent family downloading conditions to the patent family database server 17 through the external network 14. The patent family database server 17 searches for patents belonging to the selected patent family, and transmits information on the patents to the patent family downloading module 122. The information on the patents is stored in the local database server 15. In step S45, the patent family downloading module 122 begins to download the patents belonging to the patent family. The monitoring module 123 automatically monitors a patent family downloading status. In step S46, the monitoring module 123 determines whether all the patents of the patent family have been successfully downloaded. If there are patents that cannot be downloaded, in step S47, the monitoring module 123 records information on the patents that have failed to be downloaded, and stores the failure information in the local database server 15. The procedure then returns to step S43 described above. If and when all the patents of the selected patent family have been successfully downloaded, in step S48, the monitoring module 123 stores the patents in the local database server 15.

In summary, the patent family downloading system and method are fast and convenient, because they provide downloading of patent families without inputting of patent numbers one by one.

Although the present invention has been specifically described on the basis of a preferred embodiment and preferred method, the invention is not to be construed as being limited thereto. Various changes or modifications may be made to the embodiment and method without departing from the scope and spirit of the invention.

1. A patent family downloading system, comprising:
a plurality of client computers for providing interactive user interfaces for setting patent downloading conditions and displaying patent family downloading statuses;
an application server comprising:
a patent downloading module for downloading patent information from at least one remote database server according to patent downloading conditions set by users;
a downloading condition generating module for generating one or more patent family downloading conditions according to a patent selected as a patent family downloading object that needs to be downloaded;
a patent family downloading module for downloading patent information on a patent family from a patent family database server according to said patent family downloading conditions; and
a monitoring module for automatically monitoring patent family downloading statuses; and
a local database server for storing the patent information.

2. The patent family downloading system according to claim 1, wherein the patent information includes any one or more of patent numbers, patent names, patent abstracts, patent priorities, patent assignees, patent specifications and patent figures.

3. The patent family downloading system according to claim 1, wherein patent numbers are set as default downloading conditions for patent families.

4. The patent family downloading system according to claim 1, wherein various patent family downloading statuses include patents that have been downloaded, patents that have failed to be downloaded, and a status of any patent that is currently being downloaded.

5. A patent family downloading method, comprising the steps of:
setting one or more patent downloading conditions;
downloading patents according to said patent downloading conditions;
selecting a patent as a patent family downloading object;
generating patent family downloading conditions;
searching for patents belonging to the selected patent family; and
monitoring a patent family downloading status.

6. The method according to claim 5, further comprising the step of determining whether all the patents belonging to the selected patent family have been downloaded.

7. The method according to claim 5, further comprising the step of recording information on any patents that have failed to be downloaded.

8. The method according to claim 5, further comprising the step of storing the downloaded patents in a local database server if and when all the patents belonging to the patent family have been downloaded.

9. The method according to claim 5, wherein the patent downloading conditions include any one or more of patent numbers, patent names, patent assignees, patent inventors, key words included in patent abstracts, and key words included in patent specifications.

10. The method according to claim 5, wherein a patent number of the patent family downloading object is set as a default downloading condition for the patent family.

11. The method according to claim 5, wherein various patent family downloading statuses include patents that have been downloaded, patents that have failed to be downloaded, and a status of any patent that is currently being downloaded.

12. A patent family downloading method, comprising the steps of:
selecting a patent as a patent family downloading object;
generating patent family downloading conditions;
searching for patents belonging to the selected patent family; and
automatically monitoring a patent family downloading status.
